(19) United States
(12) Patent Application Publication
(10) Pub. No.: US 2008/0289445 A1
(43) Pub. Date: Nov. 27, 2008

(54) Racing Bicycle Pedal Assembly having Lighter Weight

(76) Inventor: Chin-Long Hsieh, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/963,031

(22) Filed: Dec. 21, 2007

(30) Foreign Application Priority Data
May 25, 2007 (TW) 096208519

(51) Int. Cl. G05G 1/30

(52) U.S. Cl. 74/560

(57) ABSTRACT

A pedal assembly for a racing bicycle includes a pedal body, and a locking hook pivotally mounted on the pedal body by a pivot bolt and including a back plate and a hook portion formed on a top of the back plate. The back plate of the locking hook has a surface provided with at least one opening. Thus, the back plate of the locking hook is provided with at least one opening to reduce the whole weight of the pedal assembly.

### BACKGROUND OF THE INVENTION

1. Field of the Invention

The present invention relates to a pedal assembly and, more particularly, to a pedal assembly for a racing bicycle.

2. Description of the Related Art

A conventional pedal for a racing bicycle in accordance comprises a pedal body, a locking hook pivotally mounted on the pedal body by a pivot bolt, and a torsion spring mounted on the pivot bolt and biased between the locking hook and the pedal body to provide a torque of the locking hook. Thus, a rider's one shoe is snapped onto the pedal body and locked by the locking hook so that the rider's one shoe is locked on the pedal to facilitate the rider riding the racing bicycle. However, the locking hook has a solid structure to increase the whole weight of the pedal so that the pedal has a heavier weight, thereby easily causing a burden to a rider on the racing bicycle.

### BRIEF SUMMARY OF THE INVENTION

In accordance with the present invention, there is provided a pedal assembly, comprising a pedal body, and a locking hook pivotally mounted on the pedal body by a pivot bolt and including a back plate and a hook portion formed on a top of the back plate. The back plate of the locking hook has a surface provided with at least one opening.

The primary objective of the present invention is to provide a pedal assembly having a lighter weight.

Another objective of the present invention is to provide a pedal assembly for a racing bicycle, wherein the back plate Of the locking hook is provided with a plurality of openings and a plurality of recessed portions to largely reduce the whole weight of the pedal assembly.

A further objective of the present invention is to provide a pedal assembly for a racing bicycle, wherein the back plate of the locking hook is provided with a reinforcement block to receive the adjusting bolt so as to reinforce the strength of the back plate of the locking hook at the position of the through hole.

A further objective of the present invention is to provide a pedal assembly for a racing bicycle, wherein the reinforcement block of the locking hook is provided with a stop portion abutting the pivot bolt so that the reinforcement block of the locking hook is supported by the pivot bolt to prevent the locking hook from being distorted or deformed due to a force applied by the adjusting bolt.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pedal assembly for a racing bicycle in accordance with the preferred embodiment of the present invention.

FIG. 2 is an exploded perspective view of the pedal assembly for a racing bicycle as shown in FIG. 1.

FIG. 3 is a side cross-sectional view of the pedal assembly for a racing bicycle as shown in FIG. 1.

### DETAILED DESCRIPTION OF THE INVENTION

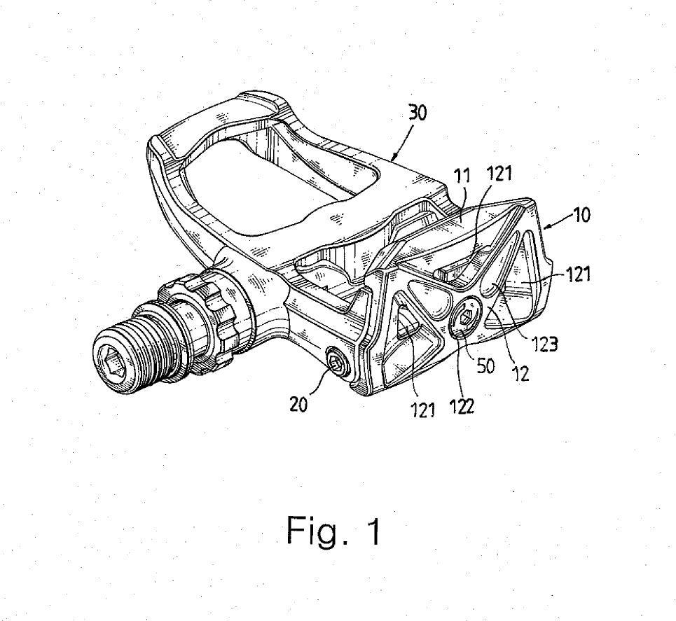

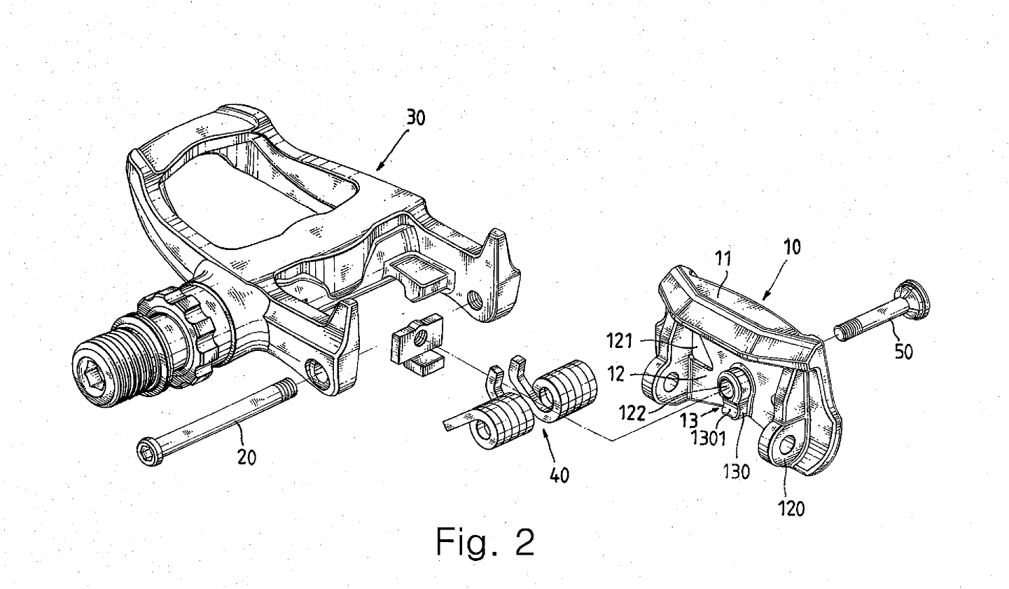

Referring to the drawings and initially to FIGS. 1 and 2, a pedal assembly for a racing bicycle in accordance with the preferred embodiment of the present invention comprises a pedal body 30, a locking hook 10 pivotally mounted on the pedal body 30 by a pivot bolt 20, a torsion spring 40 mounted on the pivot bolt 20 and biased between the locking hook 10 and the pedal body 30 to provide a torque of the locking hook 10, and an adjusting bolt 50 extending through the locking hook 10 to adjust the torque of the locking hook 10.

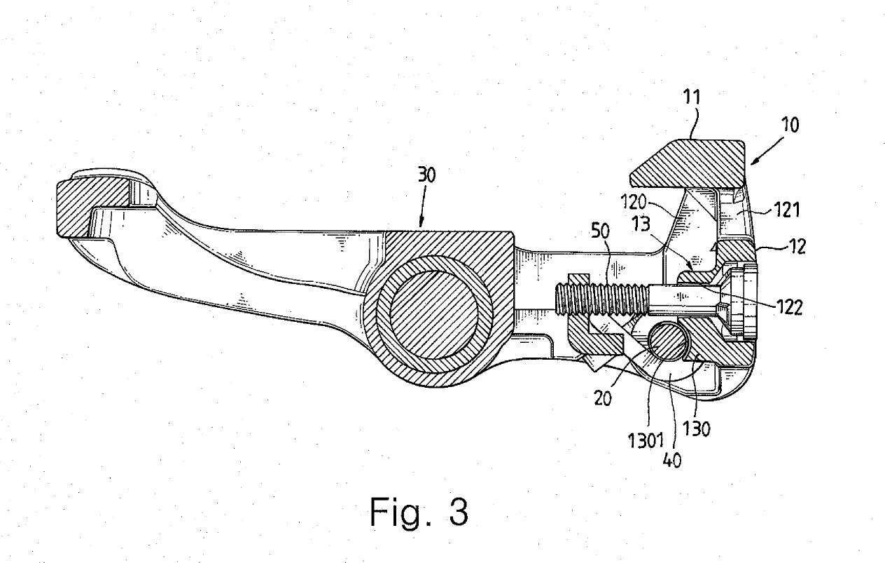

Referring to FIGS. 1-3, the locking hook 10 includes a back plate 12 and a hook portion 11 formed on a top of the back plate 12. The back plate 12 of the locking hook 10 has a flat shape and is disposed at an upright state. The back plate 12 of the locking hook 10 has a surface provided with at least one opening 121 which extends through a whole thickness of the back plate 12 of the locking hook 10. The back plate 12 of the locking hook 10 is provided with two opposite pivot ears 120 pivotally mounted on the pivot bolt 20 and a stepped through hole 122 located between the hook portion 11 and the two pivot ears 120 to allow passage of the adjusting bolt 50. In the preferred embodiment of the present invention, the back plate 12 of the locking hook 10 has a plurality of openings 121 surrounding the through hole 122. The surface of the back plate 12 of the locking hook 10 is provided with a plurality of recessed portions 123 located between the openings 121 and the through hole 122. The back plate 12 of the locking hook 10 has a side provided with a reinforcement block 13 protruding outwardly from the through hole 122 to receive the adjusting bolt 50 to reinforce a strength of the back plate 12 of the locking hook 10 at a position of the through hole 122. The through hole 122 of the locking hook 10 extends through a whole length of the reinforcement block 13. The reinforcement block 13 of the locking hook 10 extends toward the pedal body 30 and has a lower end provided with a stop-portion 130 abutting the pivot bolt 20. Preferably, the stop portion 130 of the reinforcement block 13 is provided with an arcuate concave end face 1301 to match a periphery of the pivot bolt 20.

Accordingly, the back plate 12 of the locking hook 10 is provided with a plurality of openings 121 and a plurality of recessed portions 123 to largely reduce the whole weight of the pedal assembly. In addition, the back plate 12 of the locking hook: 10 is provided with a reinforcement block 13 to receive the adjusting bolt 50 so as to reinforce the strength of the back plate 12 of the locking hook 10 at the position of the through hole 122. Further, the reinforcement block 13 of the locking hook 10 is provided with a stop portion 130 abutting the pivot bolt 20 so that the reinforcement block 13 of the locking hook 10 is supported by the pivot bolt 20 to prevent the locking hook 10 from being distorted or deformed due to a force applied by the adjusting bolt 50.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pedal assembly, comprising:
a pedal body;
a locking hook pivotally mounted on the pedal body by a pivot bolt and including a back plate and a hook portion formed on a top of the back plate;
wherein the back plate of the locking hook has a surface provided with at least one opening.

2. The pedal assembly in accordance with claim 1, wherein the back plate of the locking hook has a flat shape.

3. The pedal assembly in accordance with claim 1, wherein the back plate of the locking hook is disposed at an upright state.

4. The pedal assembly in accordance with claim 1, wherein the opening extends through a whole thickness of the back plate of the locking hook.

5. The pedal assembly in accordance with claim 1, further comprising:
an adjusting bolt extending through the locking hook;
wherein the back plate of the locking hook is provided with a through hole;
the back plate of the locking hook has a plurality of openings surrounding the through hole.

6. The pedal assembly in accordance with claim 5, wherein
the back plate of the locking hook is provided with two opposite pivot ears pivotally mounted on the pivot bolt;
the through hole of the locking hook is located between the hook portion and the two pivot ears to allow passage of the adjusting bolt.

7. The pedal assembly in accordance with claim 5, wherein the surface of the back plate of the locking hook is provided with a plurality of recessed portions located between the openings and the through hole.

8. The pedal assembly in accordance with claim 5, wherein the back plate of the locking hook has a side provided with a reinforcement block protruding outwardly from the through hole to receive the adjusting bolt.

9. The pedal assembly in accordance with claim 8, wherein the through hole of the locking hook extends through a whole length of the reinforcement block.

10. The pedal assembly in accordance with claim 8, wherein the reinforcement block of the locking hook extends toward the pedal body.

11. The pedal assembly in accordance with claim 8, wherein the reinforcement block of the locking hook has a lower end provided with a stop portion abutting the pivot bolt.

12. The pedal assembly in accordance with claim 11, wherein the stop portion of the reinforcement block is provided with an arcuate concave end face to match a periphery of the pivot bolt.

13. The pedal assembly in accordance with claim 11, wherein the reinforcement block of the locking hook is supported by the pivot bolt.

14. The pedal assembly in accordance with claim 1, further comprising a torsion spring mounted on the pivot bolt and biased between the locking hook and the pedal body to provide a torque of the locking hook.
